(19) United States
(12) Patent Application Publication
(10) Pub. No.: US 2008/0245210 A1
(43) Pub. Date: Oct. 9, 2008

(54) Musical instrument stand having a height adjusting function

(76) Inventor: Cheng-Lung Chang, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/732,750

(22) Filed: Apr. 4, 2007

(51) Int. Cl. G10D 13/02

(52) U.S. Cl. 84/421

(57) ABSTRACT

A musical instrument stand includes a base unit, a support frame, an adjusting seat, an upright support tube, and a pedal unit. The base unit includes a bottom plate and an upright support rod. The support frame includes a first clamping member, two support legs, a second clamping member and two adjusting levers. Thus, the first clamping member and the second clamping member are rotatable about the support rod so that the support frame is rotatable about the support rod freely so as to adjust the horizontal position and angle of the support frame. In addition, the adjusting seat is movable on the support rod to move the support tube and the pedal of the pedal unit so as to adjust the height of the pedal independently.

### BACKGROUND OF THE INVENTION

1. Field of the Invention

The present invention relates to a musical instrument stand and, more particularly, to a tread-type cymbal stand.

2. Description of the Related Art

A conventional musical instrument stand comprises a base member, an upright support tube having a lower end mounted on the base member and an upper end provided with a fixed cymbal and a movable cymbal, a support frame foldably mounted on a mediate portion of the support tube, a pedal unit mounted on the base member, and a chain unit mounted in the support tube and connected between the movable cymbal and the pedal unit. However, the height of the pedal unit cannot be adjusted to fit users of different statures, thereby easily causing inconvenience to the user. In addition, the horizontal position of the support frame is fixed and cannot be adjusted to fit other musical instrument.

### BRIEF SUMMARY OF THE INVENTION

The primary objective of the present invention is to provide a musical instrument stand having a height adjusting function.

Another objective of the present invention is to provide a musical instrument stand, wherein when the first fastening bolt and the second fastening bolt are unscrewed, the first clamping member and the second clamping member of the support frame are rotatable about the support rod of the base unit so that the support frame is rotatable about the support rod of the base unit freely so as to adjust the horizontal position and angle of the support frame freely and largely.

A further objective of the present invention is to provide a musical instrument stand, wherein when the second fastening bolt is unscrewed, the second clamping member of the support frame is movable on the support rod of the base unit to move the adjusting levers and the support legs so as to adjust the height of the support legs.

A further objective of the present invention is to provide a musical instrument stand, wherein when the screw member is unscrewed, the adjusting seat is movable on the support rod of the base unit to move the support tube and the pedal of the pedal unit so as to adjust the height of the pedal of the pedal unit independently.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a musical instrument stand in accordance with the preferred embodiment of the present invention.

FIG. 2 is an exploded perspective view of the musical instrument stand as shown in FIG. 1.

FIG. 3 is a side view of the musical instrument stand as shown in FIG. 1.

FIG. 4 is a top operational view of the musical instrument stand as shown in FIG. 1.

FIG. 5 is a schematic operational view of the musical instrument stand as shown in FIG. 3.

FIG. 6 is an exploded perspective view of a musical instrument stand in accordance with another preferred embodiment of the present invention.

FIG. 7 is a locally perspective enlarged view of an adjusting seat of the musical instrument stand as shown in FIG. 6.

FIG. 8 is an exploded perspective view of a musical instrument stand in accordance with another preferred embodiment of the present invention.

FIG. 9 is a locally perspective enlarged view of an adjusting seat of the musical instrument stand as shown in FIG. 8.

FIG. 10 is a perspective cross-sectional view of the adjusting seat of the musical instrument stand taken along line 10-10 as shown in FIG. 9.

FIG. 11 is an exploded perspective view of a musical instrument stand in accordance with another preferred embodiment of the present invention.

FIG. 12 is a locally perspective enlarged view of a sleeve of the musical instrument stand as shown in FIG. 11.

FIG. 13 is an exploded perspective view of a musical instrument stand in accordance with another preferred embodiment of the present invention.

FIG. 14 is a locally perspective enlarged view of the musical instrument stand as shown in FIG. 13.

FIG. 15 is an exploded perspective view of a musical instrument stand in accordance with another preferred embodiment of the present invention.

FIG. 16 is a locally perspective enlarged view of an adjusting seat of the musical instrument stand as shown in FIG. 15.

FIG. 17 is a locally perspective enlarged view of a clamping sleeve of the musical instrument stand as shown in FIG. 15.

FIG. 18 is an exploded perspective view of a musical instrument stand in accordance with another preferred embodiment of the present invention.

FIG. 19 is a locally perspective enlarged view of an adjusting seat of the musical instrument stand as shown in FIG. 18.

FIG. 20 is a locally perspective enlarged view of a clamping piece of the musical instrument stand as shown in FIG. 18.

FIG. 21 is a locally perspective enlarged view of a bushing of the musical instrument stand as shown in FIG. 18.

FIG. 22 is an exploded perspective view of a musical instrument stand in accordance with another preferred embodiment of the present invention.

FIG. 23 is a locally perspective enlarged -view of the musical instrument stand as shown in FIG. 22.

### DETAILED DESCRIPTION OF THE INVENTION

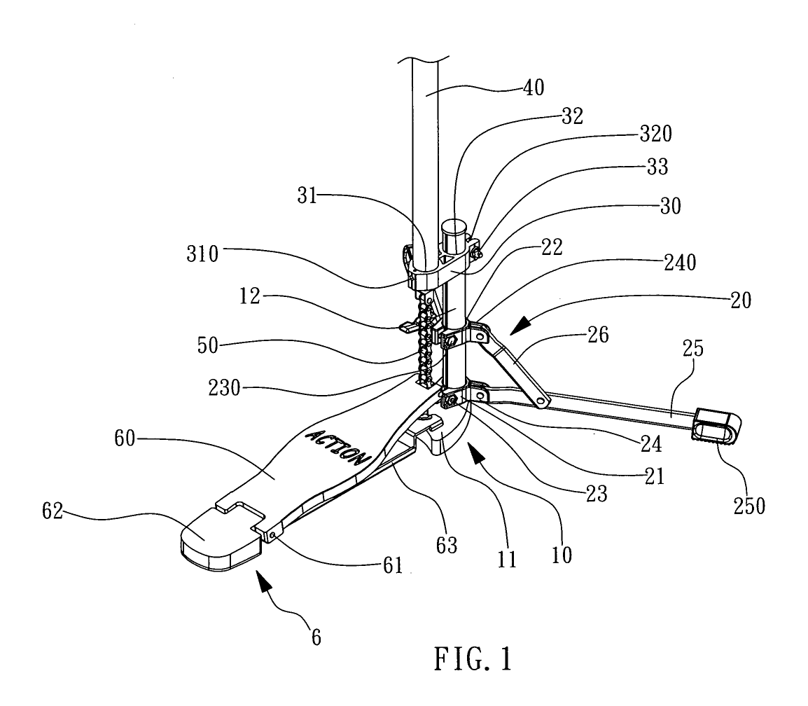

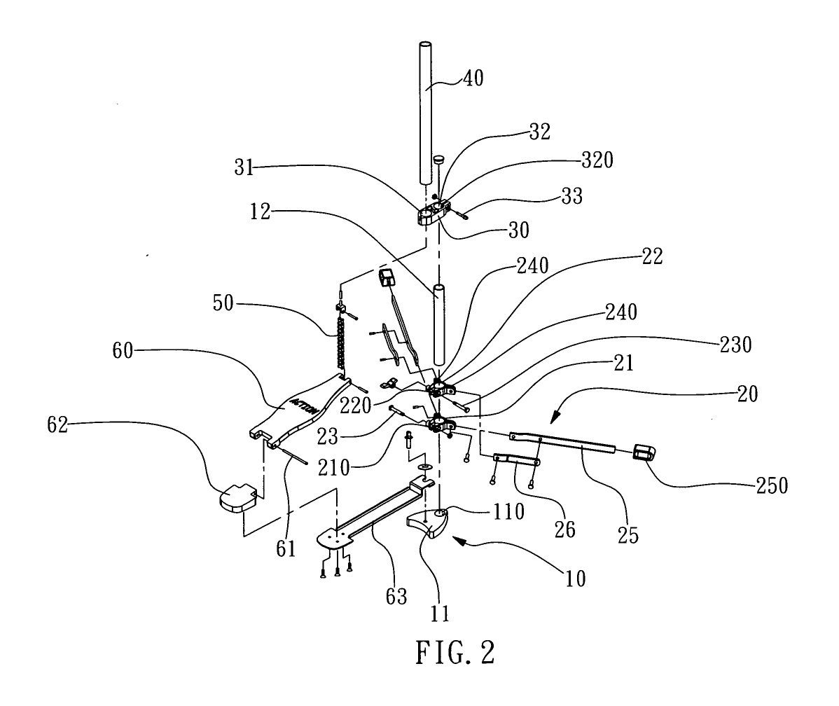

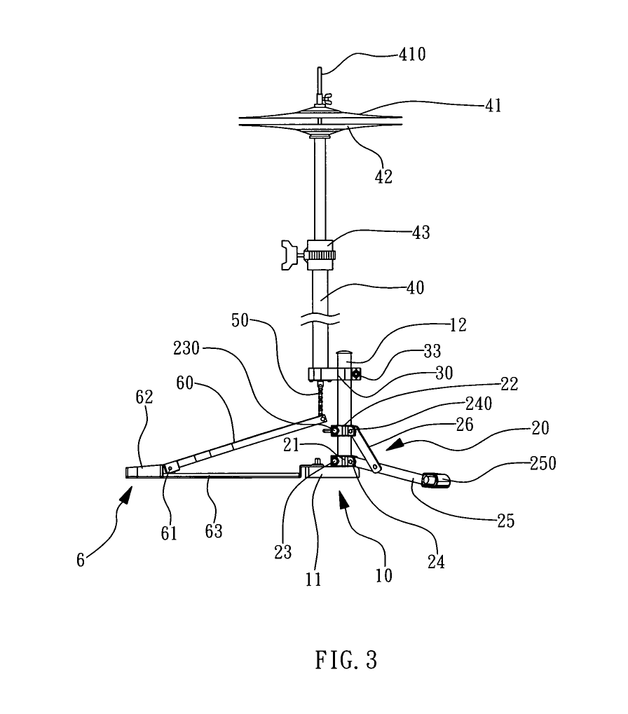

Referring to the drawings and initially to FIGS. 1-3, a musical instrument stand in accordance with the preferred embodiment of the present invention comprises a base unit 10 including a bottom plate 11 and an upright support rod 12 mounted on the bottom plate 11, a support frame 20 mounted on the base unit 10 and including a first clamping member 21 adjustably mounted on the support rod 12 of the base unit 10, two support legs 25 each mounted on the first clamping member 21, a second clamping member 22 adjustably mounted on the support rod 12 of the base unit 10 and two adjusting levers 26 each connected between the second clamping member 22 and a respective support leg 25, an adjusting seat 30 adjustably mounted on the support rod 12 of the base unit 10, an upright support tube 40 mounted on the adjusting seat 30, a fixed cymbal 42 mounted on the support tube 40, a movable cymbal 41 mounted on the support tube 40, a pedal unit 6 mounted on the base unit 10, and a chain unit 50 connected between the movable cymbal 41 and the pedal unit 60.

The bottom plate 11 of the base unit 10 has a substantially triangular shape and has a side formed with a mounting hole 110 for mounting a lower end of the support rod 12.

The first clamping member 21 of the support frame 20 has a flexible feature and has a side formed with a first clamping slit 210 to allow passage of a first fastening bolt 23 which is rotated to tighten the first clamping slit 210 of the first clamping member 21 to lock the first clamping member 21 onto the support rod 12 of the base unit 10 or loosen the first clamping slit 210 of the first clamping member 21 to unlock the first clamping member 21 from the support rod 12 of the base unit 10. The first clamping member 21 of the support frame 20 is located above the bottom plate 11 of the base unit 10 and has a periphery formed with two first pivot ears 24.

The second clamping member 22 of the support frame 20 has a flexible feature and has a side formed with a second clamping slit 220 to allow passage of a second fastening bolt 230 which is rotated to tighten the second clamping slit 220 of the second clamping member 22 to lock the second clamping member 22 onto the support rod 12 of the base unit 10 or loosen the second clamping slit 220 of the second clamping member 22 to unlock the second clamping member 22 from the support rod 12 of the base unit 10. The second clamping member 22 of the support frame 20 is located above the first clamping member 21 and has a periphery formed with two second pivot ears 240.

Each of the support legs 25 of the support frame 20 has a first end pivotally connected with a respective first pivot ear 24 of the first clamping member 21 and a second end provided with a foot pad 250.

Each of the adjusting levers 26 of the support frame 20 has a first end pivotally connected with a respective second pivot ear 240 of the second clamping member 22 and a second end pivotally mounted on a respective support leg 25.

The adjusting seat 30 is located above the second clamping member 22 of the support frame 20 and has a first end formed with a first mounting hole 32 mounted on the support rod 12 of the base unit 10 and a second end formed with a second mounting hole 31 parallel with the first mounting hole 32. The adjusting seat 30 has a side formed with a clamping split 320 connected to the first mounting hole 32 to allow passage of a screw member 33 which is rotated to tighten the clamping split 320 of the adjusting seat 30 to lock the adjusting seat 30 onto the support rod 12 of the base unit 10 or loosen the clamping split 320 of the adjusting seat 30 to unlock the adjusting seat 30 from the support rod 12 of the base unit 10.

The support tube 40 has an upper end provided with the fixed cymbal 42 and the movable cymbal 41, a mediate portion provided with a height adjusting device 43 to lift or lower the fixed cymbal 42 and the movable cymbal 41 and a lower end mounted in the second mounting hole 31 of the adjusting seat 30 and retained by a set screw 310.

The pedal unit 6 includes a support board 63 having a first end secured to the bottom plate 11 of the base unit 10, a mounting block 62 secured to a second end of the support board 63 and a pedal 60 disposed at an inclined state and having a first end pivotally mounted on the mounting block 62 by a pivot pin 61.

The chain unit 50 is received in the support tube 40 and has a first end secured to and movable by a pull bar 410 of the movable cymbal 41 and a second end protruded from the lower end of the movable cymbal 41 and secured to a second end of the pedal 60 of the pedal unit 6 to move the pedal 60 of the pedal unit 6.

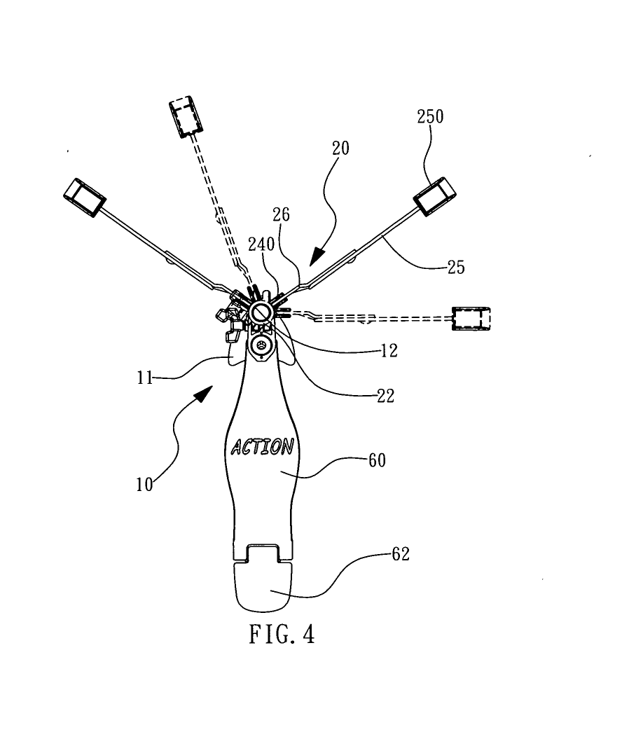

In operation, referring to FIG. 4 with reference to FIGS. 1-3, when the first fastening bolt 23 and the second fastening bolt 230 are unscrewed, the first clamping member 21 and the second clamping member 22 of the support frame 20 are rotatable about the support rod 12 of the base unit 10 so that the support frame 20 is rotatable about the support rod 12 of the base unit 10 freely so as to adjust the horizontal position and angle of the support frame 20.

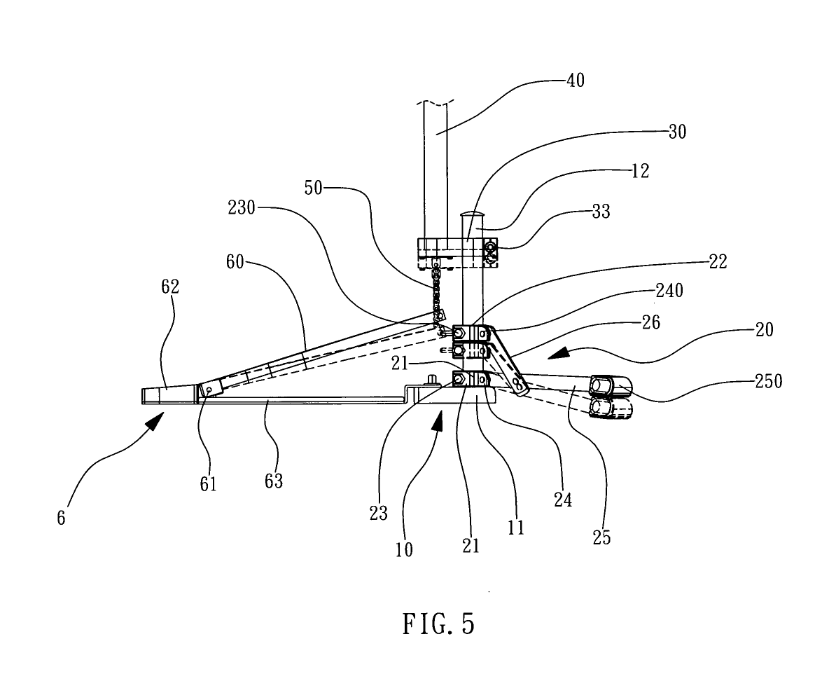

Alternatively, referring to FIG. 5 with reference to FIGS. 1-3, when the second fastening bolt 230 is unscrewed, the second clamping member 22 of the support frame 20 is movable on the support rod 12 of the base unit 10 to move the adjusting levers 26 and the support legs 25 so as to adjust the height of the support legs 25. In addition, when the screw member 33 is unscrewed, the adjusting seat 30 is movable on the support rod 12 of the base unit 10 to move the support tube 40 and the pedal 60 of the pedal unit 6 so as to adjust the height of the pedal 60 of the pedal unit 6.

Accordingly, when the first fastening bolt 23 and the second fastening bolt 230 are unscrewed, the first clamping member 21 and the second clamping member 22 of the support frame 20 are rotatable about the support rod 12 of the base unit 10 so that the support frame 20 is rotatable about the support rod 12 of the base unit 10 freely so as to adjust the horizontal position and angle of the support frame 20 freely and largely. In addition, when the second fastening bolt 230 is unscrewed, the second clamping member 22 of the support frame 20 is movable on the support rod 12 of the base unit 10 to move the adjusting levers 26 and the support legs 25 so as to adjust the height of the support legs 25. Further, when the screw member 33 is unscrewed, the adjusting seat 30 is movable on the support rod 12 of the base unit 10 to move the support tube 40 and the pedal 60 of the pedal unit 6 so as to adjust the height of the pedal 60 of the pedal unit 6 independently.

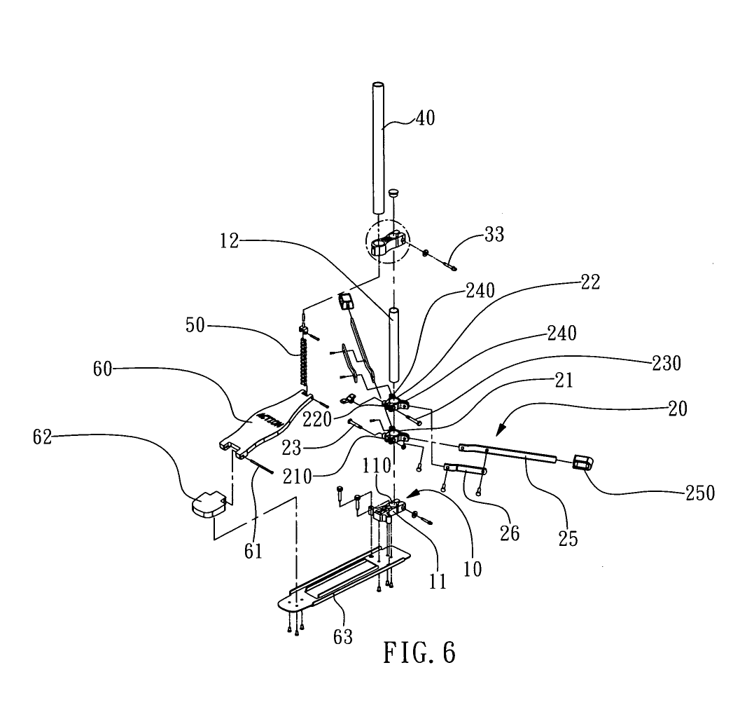

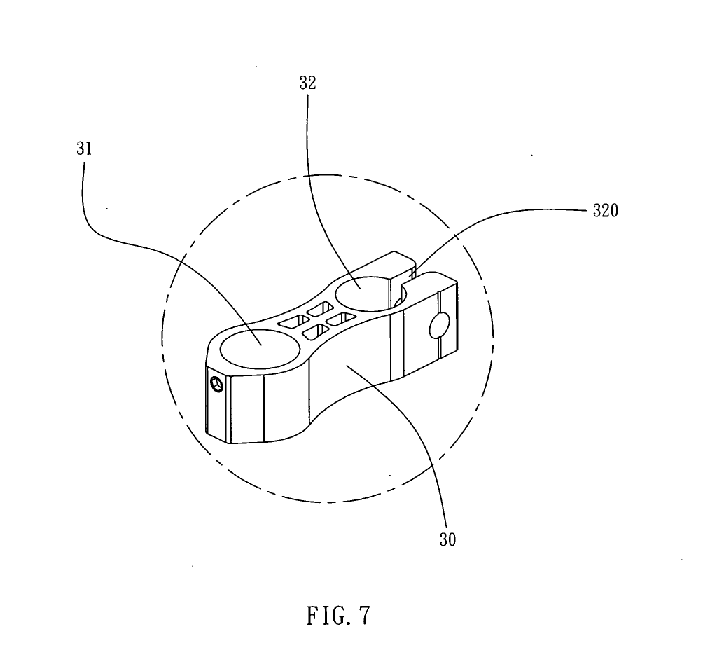

Referring to FIGS. 6 and 7, the shapes of the adjusting seat 30, the bottom plate 11 of the base unit 10 and the support board 63 of the pedal unit 6 are changed.

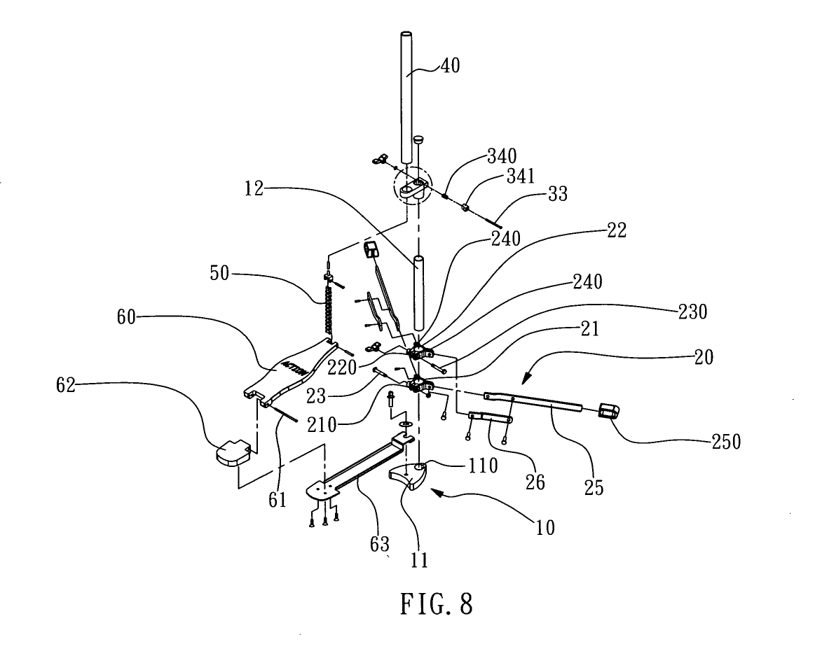

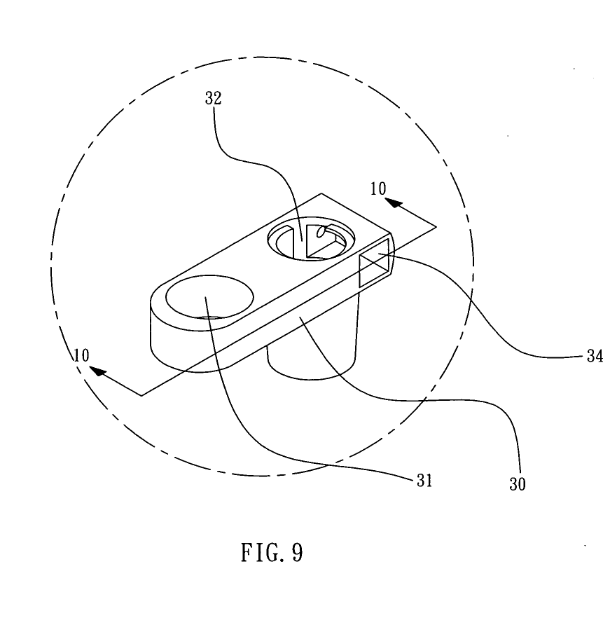

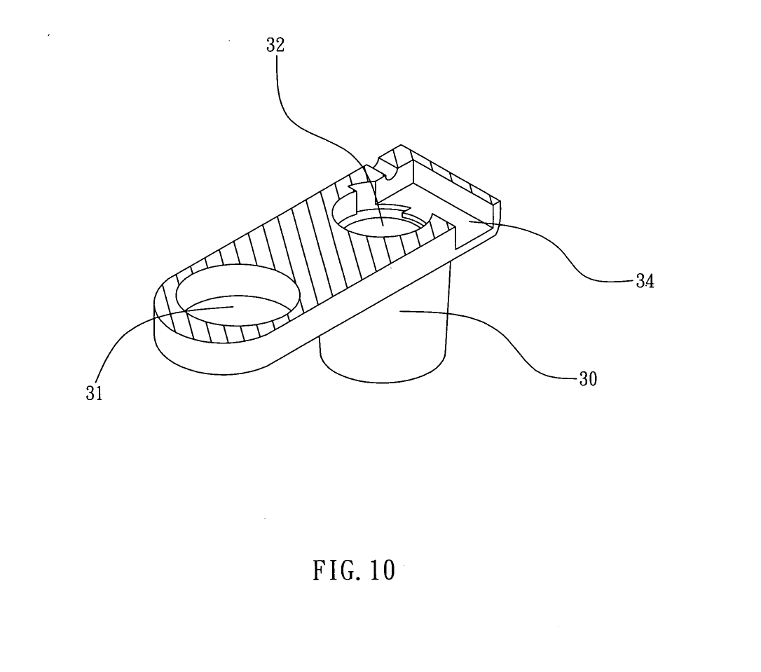

Referring to FIGS. 8-10, the adjusting seat 30 has a side formed with a receiving chamber 34 connected to the first mounting hole 32 to receive a press block 341 which is movable to press the support rod 12 of the base unit 10, and the musical instrument stand further comprises a screw member 33 extended through the press block 341 and rotatable to move the press block 341 to press or loose the support rod 12 of the base unit 10 to lock the adjusting seat 30 onto the support rod 12 of the base unit 10 or unlock the adjusting seat 30 from the support rod 12 of the base unit 10, and an elastic member 340 mounted on the screw member 33 and biased on the press block 341.

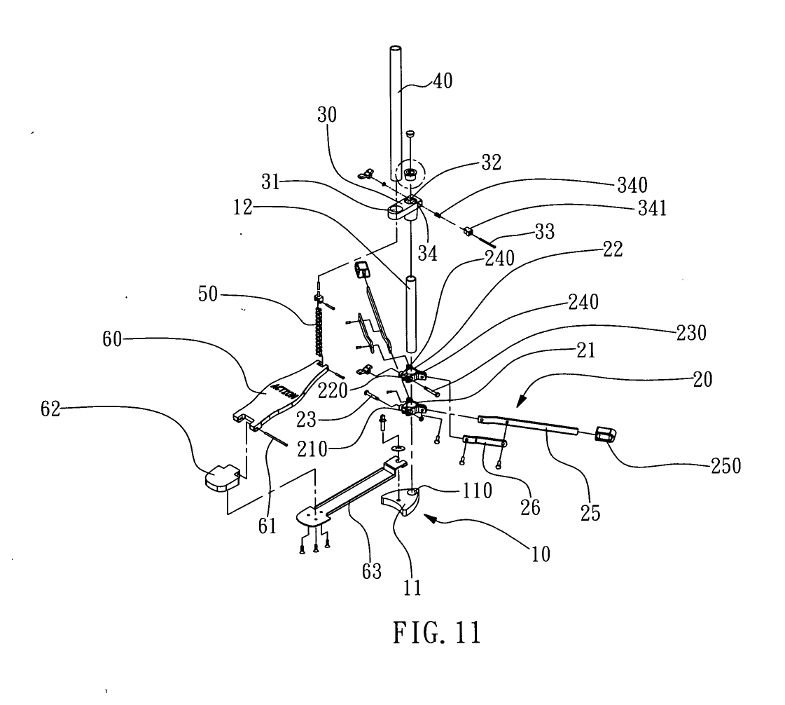

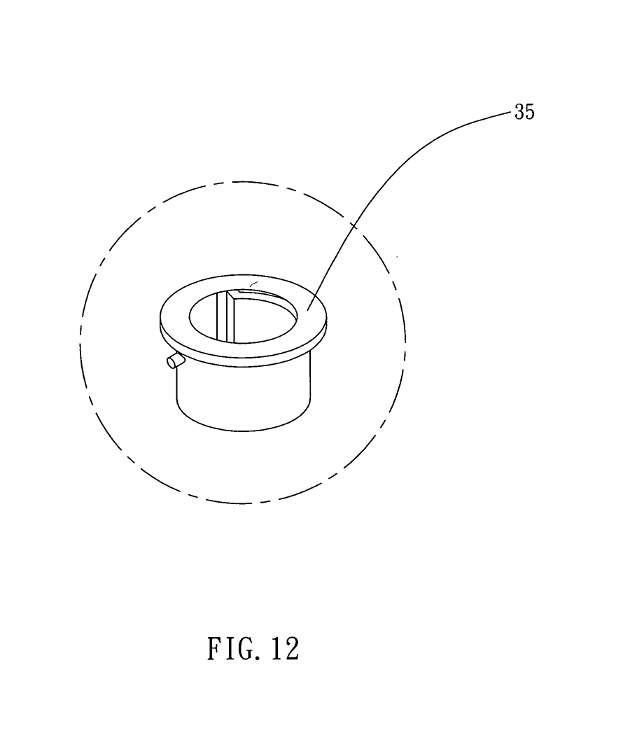

Referring to FIGS. 11 and 12, the musical instrument stand further comprises a soft sleeve 35 mounted in the first mounting hole 32 of the adjusting seat 30 and located between the press block 341 and the support rod 12 of the base unit 10 to prevent the support rod 12 of the base unit 10 from being broken by the press block 341.

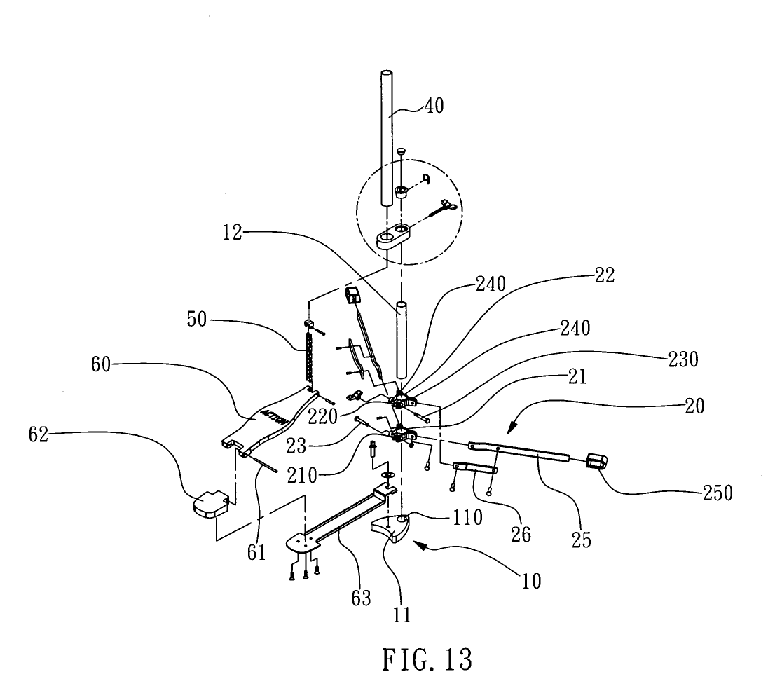

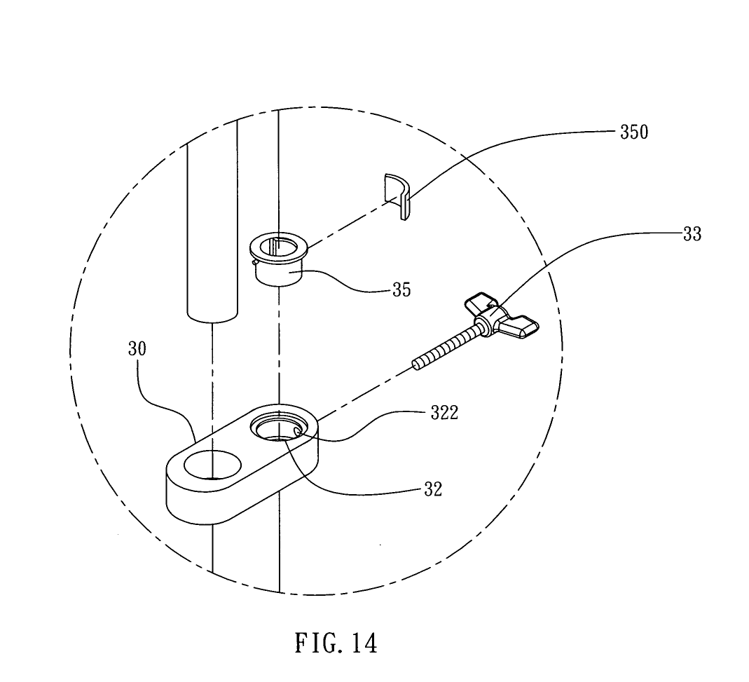

Referring to FIGS. 13 and 14, the adjusting seat 30 has a side formed with a screw bore 322 connected to the first mounting hole 32, and the musical instrument stand further comprises a soft sleeve 35 mounted between the first mounting hole 32 of the adjusting seat 30 and the support rod 12 of the base unit 10, a washer 350 mounted in the first mounting hole 32 of the adjusting seat 30 and rested on the sleeve 35, and a screw member 33 screwed into the screw bore 322 of the adjusting seat 30 and rotatable to move the washer 350 to press the sleeve 35 toward the support rod 12 of the base unit 10 so as to lock the adjusting seat 30 onto the support rod 12 of the base unit 10.

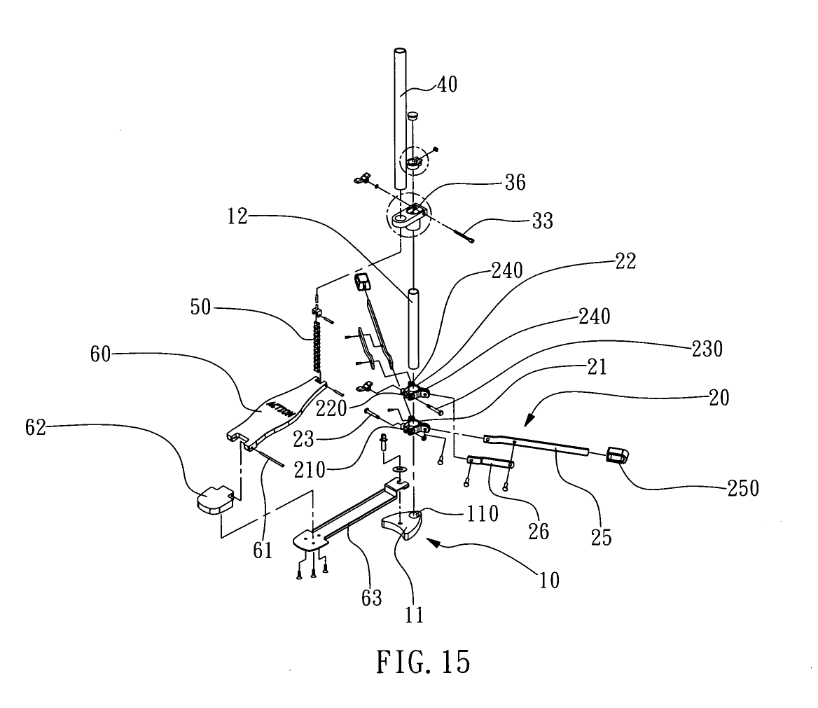

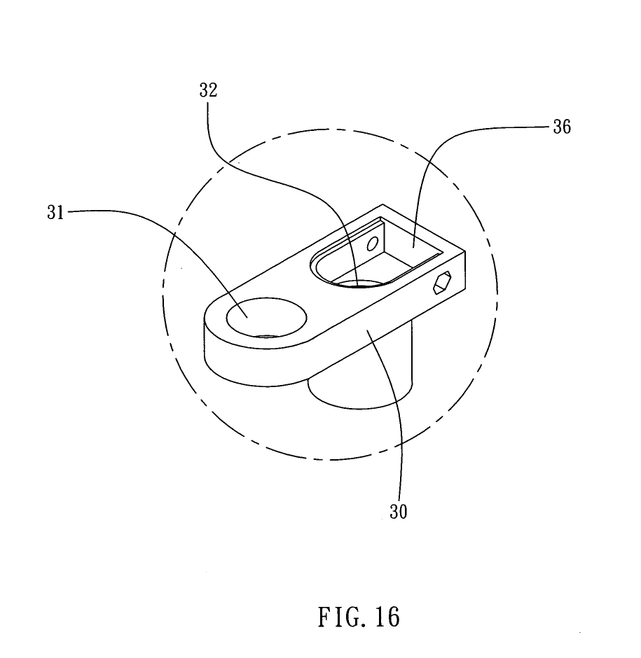

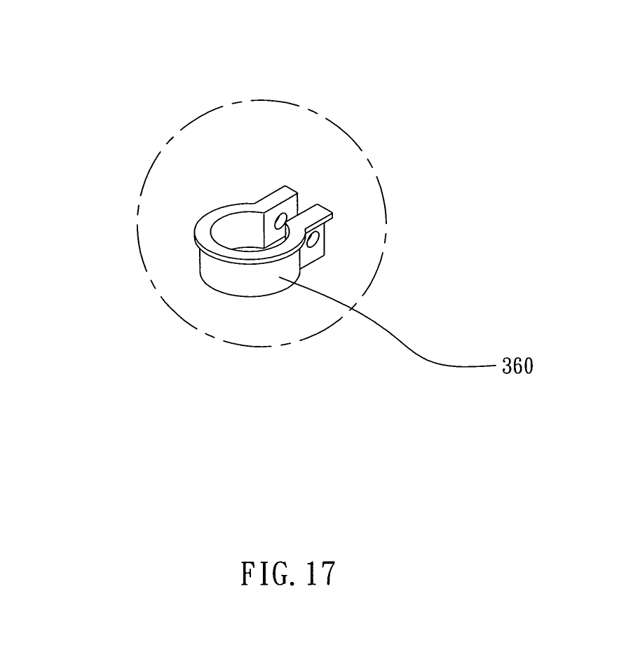

Referring to FIGS. 15-17, the adjusting seat 30 has a side formed with a receiving chamber 36 connected to the first mounting hole 32 to receive a substantially C-shaped flexible clamping sleeve 360 which is located between the support rod 12 of the base unit 10 and the adjusting seat 30, and the musical instrument stand further comprises a screw member 33 extended through the adjusting seat 30 and the clamping sleeve 360 and rotatable to compress or expand the clamping sleeve 360 to press or loose the support rod 12 of the base unit 10 so as to lock the adjusting seat 30 onto the support rod 12 of the base unit 10 or unlock the adjusting seat 30 from the support rod 12 of the base unit 10.

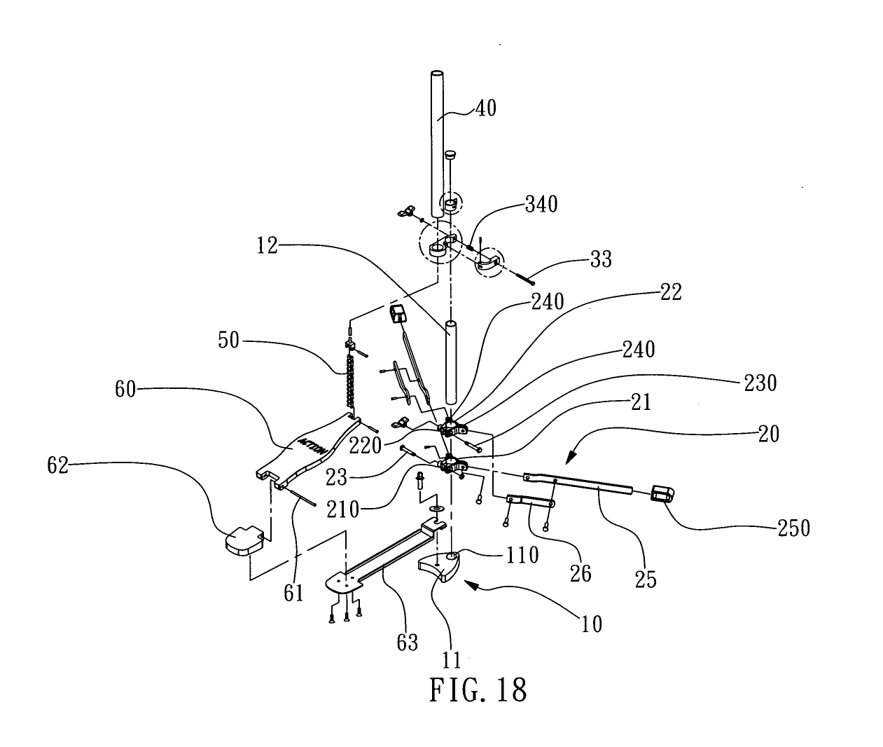

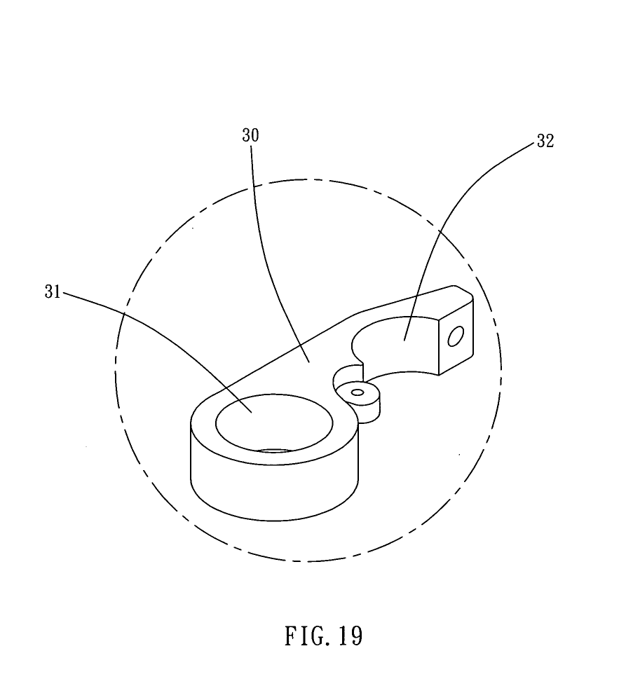

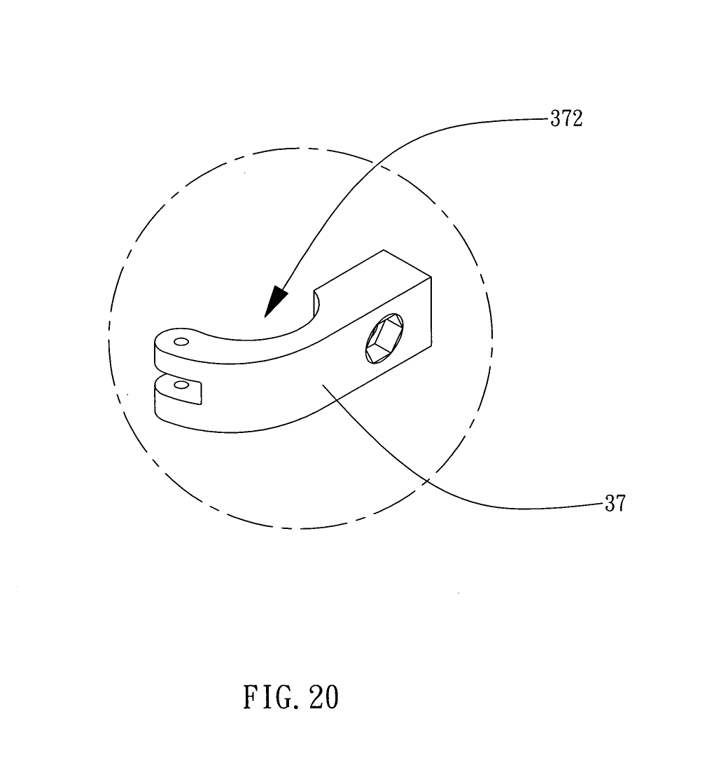

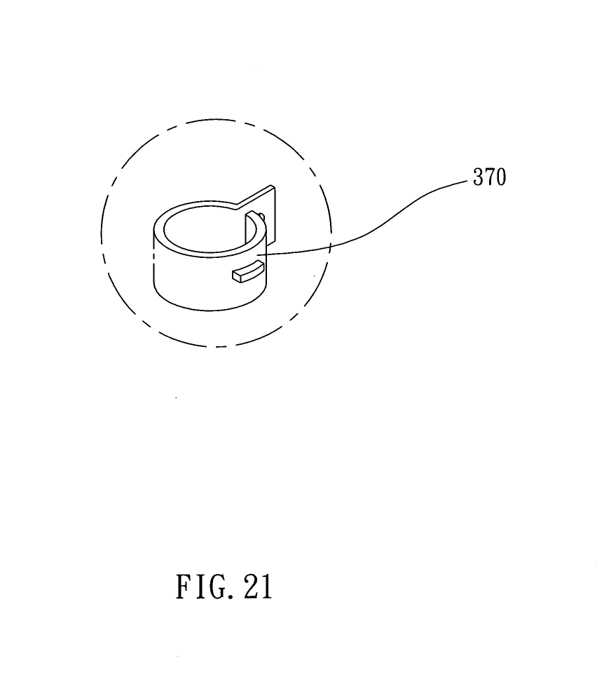

Referring to FIGS. 18-21, the musical instrument stand further comprises a clamping piece 37 having a first end pivotally connected with the adjusting seat 30, a mediate portion formed with a receiving recess 372 juxtaposed to the first mounting hole 32 of the adjusting seat 30 and a second end spaced from the adjusting seat 30, a bushing 370 mounted on the support rod 12 of the base unit 10 and located between the first mounting hole 32 of the adjusting seat 30 and the receiving recess 372 of the clamping piece 37, and a screw member 33 extended through the second end of the clamping piece 37 and the adjusting seat 30 and rotatable to compress or expand the bushing 370 to press or loose the support rod 12 of the base unit 10 so as to lock the adjusting seat 30 onto the support rod 12 of the base unit 10 or unlock the adjusting seat 30 from the support rod 12 of the base unit 10.

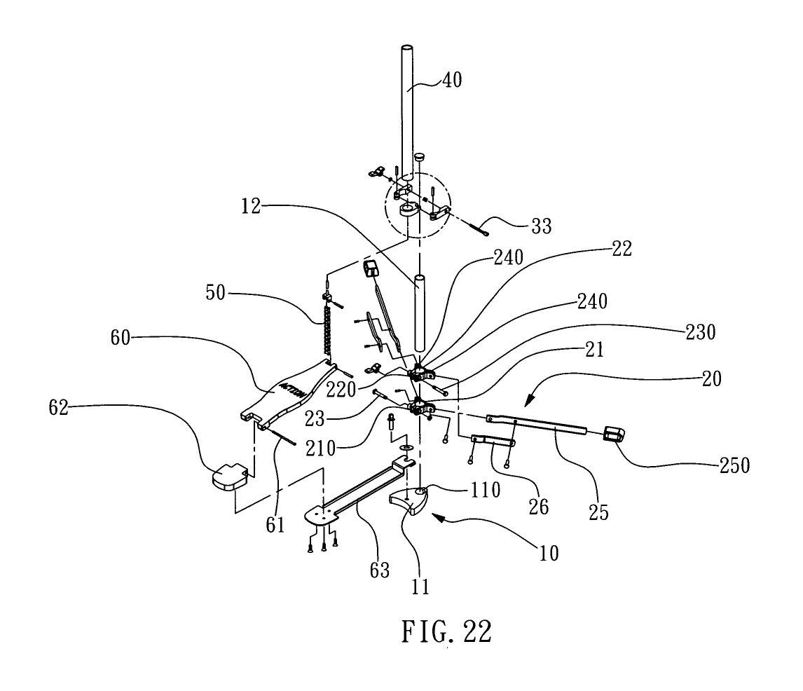

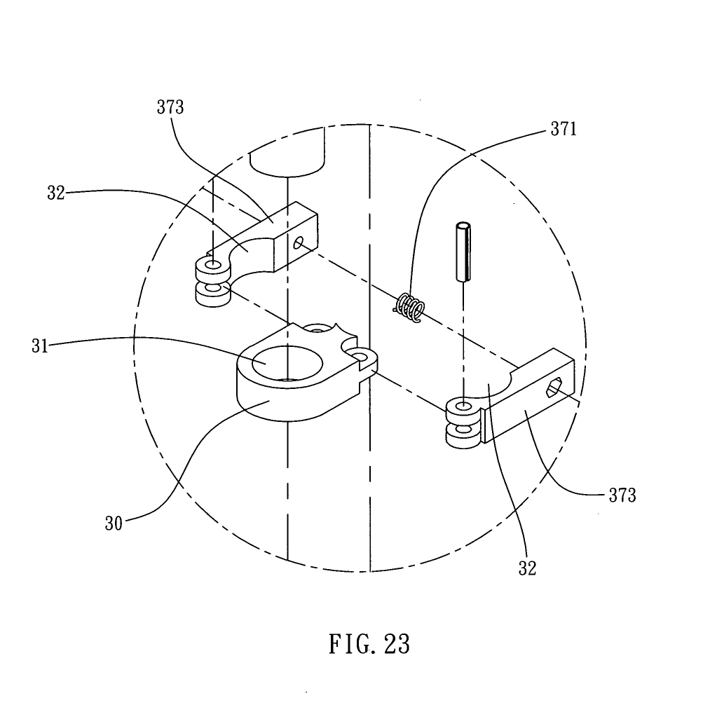

Referring to FIGS. 22 and 23, the first mounting hole 32 of the adjusting seat 30 is defined by two clamping pieces 373 each having a first end pivotally connected with the second end of the adjusting seat 30, a mediate portion formed with the first mounting hole 32 and a second end spaced from each other, and the musical instrument stand further comprises a screw member 33 extended through the second ends of the clamping pieces 373 and rotatable to compress or expand the clamping pieces 373 to press or loose the support rod 12 of the base unit 10 so as to lock the adjusting seat 30 onto the support rod 12 of the base unit 10 or unlock the adjusting seat 30 from the support rod 12 of the base unit 10, and an elastic member 371 mounted on the screw member 33 and biased between the second ends of the clamping pieces 373.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A musical instrument stand, comprising:
a base unit including a bottom plate and an upright support rod mounted on the bottom plate;
a support frame mounted on the base unit and including a first clamping member adjustably mounted on the support rod of the base unit, two support legs each mounted on the first clamping member, a second clamping member adjustably mounted on the support rod of the base unit and two adjusting levers each connected between the second clamping member and a respective support leg;
an adjusting seat adjustably mounted on the support rod of the base unit;
an upright support tube mounted on the adjusting seat;
a pedal unit mounted on the base unit.

2. The musical instrument stand in accordance with claim 1, wherein the first clamping member of the support frame has a flexible feature and has a side formed with a first clamping slit to allow passage of a first fastening bolt which is rotated to tighten the first clamping slit of the first clamping member to lock the first clamping member onto the support rod of the base unit or loosen the first clamping slit of the first clamping member to unlock the first clamping member from the support rod of the base unit.

3. The musical instrument stand in accordance with claim 2, wherein the second clamping member of the support frame has a flexible feature and has a side formed with a second clamping slit to allow passage of a second fastening bolt which is rotated to tighten the second clamping slit of the second clamping member to lock the second clamping member onto the support rod of the base unit or loosen the second clamping slit of the second clamping member to unlock the second clamping member from the support rod of the base unit.

4. The musical instrument stand in accordance with claim 1, wherein the first clamping member of the support frame has a periphery formed with two first pivot ears, and each of the support legs of the support frame has a first end pivotally connected with a respective first pivot ear of the first clamping member and a second end provided with a foot pad.

5. The musical instrument stand in accordance with claim 4, wherein the second clamping member of the support frame has a periphery formed with two second pivot ears, and each of the adjusting levers of the support frame has a first end pivotally connected with a respective second pivot ear of the second clamping member and a second end pivotally mounted on a respective support leg.

6. The musical instrument stand in accordance with claim 1, wherein the first clamping member of the support frame is located above the bottom plate of the base unit, the second clamping member of the support frame is located above the first clamping member, and the adjusting seat is located above the second clamping member of the support frame.

7. The musical instrument stand in accordance with claim 1, wherein the adjusting seat has a first end formed with a first mounting hole mounted on the support rod of the base unit.

8. The musical instrument stand in accordance with claim 7, wherein:
the adjusting seat has a second end formed with a second mounting hole parallel with the first mounting hole;
the support tube has a lower end mounted in the second mounting hole of the adjusting seat.

9. The musical instrument stand in accordance with claim 7, wherein the adjusting seat has a side formed with a clamping split connected to the first mounting hole to allow passage of a screw member which is rotated to tighten the clamping split of the adjusting seat to lock the adjusting seat onto the support rod of the base unit or loosen the clamping split of the adjusting seat to unlock the adjusting seat from the support rod of the base unit.

10. The musical instrument stand in accordance with claim 1, wherein the pedal unit includes a support board having a first end secured to the bottom plate of the base unit, a mounting block secured to a second end of the support board and a pedal disposed at an inclined state and having a first end pivotally mounted on the mounting block by a pivot pin.

11. The musical instrument stand in accordance with claim 10, wherein:
the support tube has an upper end provided with a fixed cymbal and a movable cymbal;
the musical instrument stand further comprises a chain unit connected between the movable cymbal and the pedal unit and received in the support tube and having a first end secured to and movable by a pull bar of the movable cymbal and a second end protruded from a lower end of the movable cymbal and secured to a second end of the pedal of the pedal unit to move the pedal of the pedal unit.

12. The musical instrument stand in accordance with claim 7, wherein:
the adjusting seat has a side formed with a receiving chamber connected to the first mounting hole to receive a press block which is movable to press the support rod of the base unit;
the musical instrument stand further comprises:
a screw member extended through the press block and rotatable to move the press block to press or loose the support rod of the base unit to lock the adjusting seat onto the support rod of the base unit or unlock the adjusting seat from the support rod of the base unit;
an elastic member mounted on the screw member and biased on the press block.

13. The musical instrument stand in accordance with claim 12, further comprising a soft sleeve mounted in the first mounting hole of the adjusting seat and located between the press block and the support rod of the base unit.

14. The musical instrument stand in accordance with claim 7, wherein:
the adjusting seat has a side formed with a screw bore connected to the first mounting hole;
the musical instrument stand further comprises:
a soft sleeve mounted between the first mounting hole of the adjusting seat and the support rod of the base unit;
a washer mounted in the first mounting hole of the adjusting seat and rested on the sleeve;
a screw member screwed into the screw bore of the adjusting seat and rotatable to move the washer to press the sleeve toward the support rod of the base unit so as to lock the adjusting seat onto the support rod of the base unit.

15. The musical instrument stand in accordance with claim 7, wherein:
the adjusting seat has a side formed with a receiving chamber connected to the first mounting hole to receive a substantially C-shaped flexible clamping sleeve which is located between the support rod of the base unit and the adjusting seat;
the musical instrument stand further comprises a screw member extended through the adjusting seat and the clamping sleeve and rotatable to compress or expand the clamping sleeve to press or loose the support rod of the base unit so as to lock the adjusting seat onto the support rod of the base unit or unlock the adjusting seat from the support rod of the base unit.

16. The musical instrument stand in accordance with claim 7, further comprising:
a clamping piece having a first end pivotally connected with the adjusting seat, a mediate portion formed with a receiving recess juxtaposed to the first mounting hole of the adjusting seat and a second end spaced from the adjusting seat;
a bushing mounted on the support rod of the base unit and located between the first mounting hole of the adjusting seat and the receiving recess of the clamping piece;
a screw member extended through the second end of the clamping piece and the adjusting seat and rotatable to compress or expand the bushing to press or loose the support rod of the base unit so as to lock the adjusting seat onto the support rod of the base unit or unlock the adjusting seat from the support rod of the base unit.

17. The musical instrument stand in accordance with claim 7, wherein:
the first mounting hole of the adjusting seat is defined by two clamping pieces each having a first end pivotally connected with the second end of the adjusting seat, a mediate portion formed with the first mounting hole and a second end spaced from each other;
the musical instrument stand further comprises:
a screw member extended through the second ends of the clamping pieces and rotatable to compress or expand the clamping pieces to press or loose the support rod of the base unit so as to lock the adjusting seat onto the support rod of the base unit or unlock the adjusting seat from the support rod of the base unit;
an elastic member mounted on the screw member and biased between the second ends of the clamping pieces.

18. The musical instrument stand in accordance with claim 3, wherein when the first fastening bolt and the second fastening bolt are unscrewed, the first clamping member and the second clamping member of the support frame are rotatable about the support rod of the base unit so that the support frame is rotatable about the support rod of the base unit freely;
when the second fastening bolt is unscrewed, the second clamping member of the support frame is movable on the support rod of the base unit to move the adjusting levers and the support legs.

19. The musical instrument stand in accordance with claim 10, wherein the adjusting seat is movable on the support rod of the base unit to move the support tube and the pedal of the pedal unit.

20. The musical instrument stand in accordance with claim 1, wherein the bottom plate of the base unit has a side formed with a mounting hole for mounting a lower end of the support rod.
